(19) United States
(12) Patent Application Publication
(10) Pub. No.: US 2004/0181626 A1
(43) Pub. Date: Sep. 16, 2004

(54) Partial linearly tagged cache memory system

(76) Inventor: James K. Pickett, Austin, TX (US)

Correspondence Address: Stephen J. Curran, Meyertons, Hood, Kivlin, Kowert & Goetzel, P.C., P.O. Box 398, Austin, TX, 78767, US

(21) Appl. No.: 10/387,895

(22) Filed: Mar. 13, 2003

(51) Int. Cl. G06F 12/08

(52) U.S. Cl. 711/3

(57) ABSTRACT

A partial linearly tagged cache memory system includes a cache storage coupled to a linear tag logic unit. The cache storage may store a plurality of cache lines. The cache storage may also store a respective partial linear tag corresponding to each of the plurality of cache lines. The linear tag logic unit may receive a cache request including a linear address. If a subset of bits of the linear address match the partial linear tag corresponding to a particular cache line, the linear tag logic unit may select that particular cache line. The linear address includes a first subset of bits forming an index and a second subset of bits. The partial linear tag corresponding to the particular cache line includes some, but not all, of the second subset of bits.

### BACKGROUND OF THE INVENTION

1. Field of the Invention

This invention relates to microprocessors and, more particularly, to cache memory systems within microprocessors.

2. Description of the Related Art

Typical computer systems may contain one or more microprocessors which may be coupled to one or more system memories. The processors may execute code and operate on data that is stored within the system memories. It is noted that as used herein, the term “processor” is synonymous with the term microprocessor. To facilitate the fetching and storing of instructions and data, a processor typically employs some type of memory system. In addition, to expedite accesses to the system memory, one or more cache memories may be included in the memory system. For example, some microprocessors may be implemented with one or more levels of cache memory. In a typical microprocessor, a level one (L1) cache and a level two (L2) cache may be used, while some newer processors may also use a level three (L3) cache. In many legacy processors, the L1 cache may reside on-chip and the L2 cache may reside off-chip. However, to further improve memory access times, newer processors may use an on-chip L2 cache.

Generally speaking, the L2 cache may be larger and slower than the L1 cache. In addition, the L2 cache is often implemented as a unified cache, while the L1 cache may be implemented as a separate instruction cache and a data cache. The L1 data cache is used to hold the data most recently read or written by the software running on the microprocessor. The L1 instruction cache is similar to L1 data cache except that it holds the instructions executed most recently. It is noted that for convenience the L1 instruction cache and the L1 data cache may be referred to simply as the L1 cache, as appropriate. The L2 cache may be used to hold instructions and data that do not fit in the L1 cache. The L2 cache may be exclusive (e.g., it stores information that is not in the L1 cache) or it may be inclusive (e.g., it stores a copy of the information that is in the L1 cache).

Memory systems typically use some type of cache coherence mechanism to ensure that accurate data is supplied to a requester. The cache coherence mechanism typically uses the size of the data transferred in a single request as the unit of coherence. The unit of coherence is commonly referred to as a cache line. In some processors, for example, a given cache line may be 64 bytes, while some other processors employ a cache line of 32 bytes. In yet other processors, other numbers of bytes may be included in a single cache line. If a request misses in the L1 and L2 caches, an entire cache line of multiple words is transferred from main memory to the L2 and L1 caches, even though only one word may have been requested. Similarly, if a request for a word misses in the L1 cache but hits in the L2 cache, the entire L2 cache line including the requested word is transferred from the L2 cache to the L1 cache.

During a read or write to cacheable memory, the L1 cache is first checked to see if the requested information (e.g., instruction or data) is available. If the information is available, a hit occurs. If the information is not available, a miss occurs. If a miss occurs, then the L2 cache may be checked. Thus, when a miss occurs in the L1 cache but hits within, L2 cache, the information may be transferred from the L2 cache to the L1 cache.

Many caches may be implemented as n-way set-associative caches. This refers to the manner in which the caches are accessed. For example, an n-way set-associative cache may include n ways and m sets. Such a cache may be organized as an array of cache lines. The rows of cache lines are referred to as the sets and the columns are referred to as the ways. Thus, each of the m sets is a collection of n lines. For example, in a four-way set associative cache, each of the m sets is a collection of four cache lines.

Generally, microprocessors which implement the ×86 architecture support address relocation, thereby using several types of addresses to describe the way that memory is organized. Specifically, four types of addresses are defined by the ×86 architecture: logical addresses, effective addresses, linear addresses, and physical addresses. A logical address is a reference into a segmented address space. It includes a segment selector and the effective address. The offset into a memory segment is referred to as an effective address. The segment-selector portion of a logical address specifies a segment-descriptor entry in either a global or local descriptor table. The specified segment-descriptor entry contains the segment base address, which is the starting location of the segment in linear address space. A linear address then is formed by adding the segment base address to the effective address, thereby creating a reference to any byte location in within the supported linear address space. It is noted that linear addresses are commonly referred to as virtual addresses. Accordingly the terms may be used interchangeably. Depending on implementation (e.g., when using a flat memory model), the linear address may be identical to the logical address. A physical address is a reference into the physical address space, which is typically main memory. Physical addresses are translated from virtual addresses using page translation mechanisms.

In some conventional processors, the L1 and L2 caches may be accessed using only the physical address of the data or instruction being referenced. In such processors, the physical address may be divided into three fields: a Tag field, an Index field and an Offset field. In such an arrangement, the Index field selects the set (row) to be examined for a hit. All the cache lines of the set are initially selected (one from each way). The Tag field is generally used to select a specific cache line from the set. The physical address tag is compared with each cache line tag in the set. If a match is found, a hit is signaled and that cache line is selected for output. If a match is not found, a miss is signaled. The Offset field may be used to point to the first byte in the cache line corresponding to the memory reference. Thus, the referenced data or instruction value is read from (or written to) the selected cache line starting at the location pointed to in the Offset field.

In a physically tagged, physically indexed cache, the cache may not be accessed until the full physical address has been translated. This may result in cache access latencies associated with address translation.

In other conventional processors, the L1 and L2 caches may be accessed using a linear Index and a physical address tag to access the data or instruction being referenced. This type of cache is typically referred to as a linearly indexed and physically tagged cache. Similar to the Index field described above, the Index field selects the set (row) to be examined for a hit. However in this case, since the linear (virtual) address may be accessible before the physical address, which must be translated, part of the linear address may be used to select the set. Accordingly, a subset of the linear address bits may be used in the Index field. The Tag field may still use the physical address to select the way. Although some of the latencies associated with address translation may be accounted for, there may still be drawbacks to using the physical address tag to access the cache.

### SUMMARY OF THE INVENTION

Various embodiments of a partial linearly tagged cache system are disclosed. In one embodiment, a cache memory system includes a cache storage coupled to a linear tag logic unit. The cache storage may store a plurality of cache lines. The cache storage may also store a respective partial linear tag corresponding to each of the plurality of cache lines. The linear tag logic unit may receive a cache request including a linear address. If a subset of bits of the linear address match the partial linear tag corresponding to a particular cache line, the linear tag logic unit may select that particular cache line.

In one specific implementation, the linear address includes a first subset of bits forming an index and a second subset of bits. The partial linear tag corresponding to the particular cache line includes some, but not all, of the second subset of bits.

In another specific embodiment, the linear tag logic unit may further signal a hit and provide one or more bytes of the particular cache line to a requestor in response to the second subset of bits of the linear address matching the partial linear tag corresponding to the particular cache line.

In yet another specific embodiment, the cache memory system may also include a physical tag storage which may store a respective physical tag corresponding to each of the plurality of cache lines.

In still another specific embodiment, the cache memory system may also include a physical tag logic unit that may receive a physical address corresponding to the cache request and to determine whether the particular cache line is stored within the cache storage by comparing a subset of physical address bits with each respective physical tag. The physical tag logic unit may further provide an invalid data signal in response to signaling the miss and if the linear tag logic unit has provided the one or more bytes of the particular cache line to the requester.

### BRIEF DESCRIPTION OF THE DRAWINGS

FIG. 1 is a block diagram of one embodiment of a microprocessor.

FIG. 2 is a block diagram of one embodiment of a linearly tagged cache system.

FIG. 3 is a logical diagram of one embodiment of a linearly tagged cache system.

FIG. 4 is a diagram illustrating one embodiment of a linear address and an exemplary partial linear tag.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

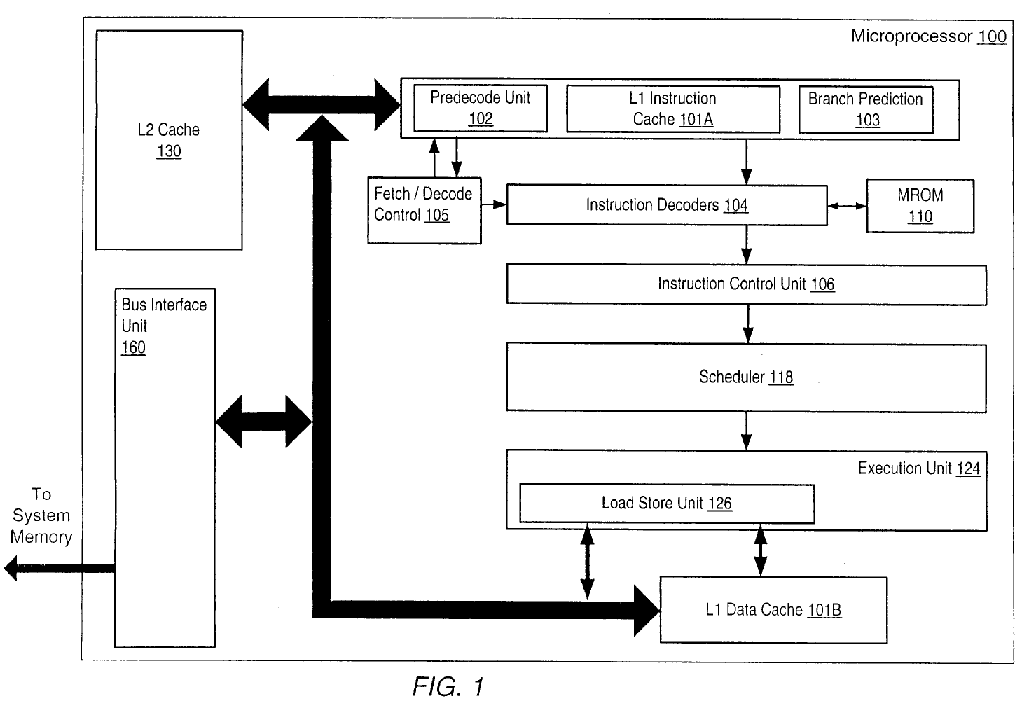

Turning now to FIG. 1, a block diagram of one embodiment of an exemplary microprocessor 100 is shown. Microprocessor 100 is configured to execute instructions stored in a system memory (not shown). Many of these instructions operate on data stored in the system memory. It is noted that the system memory may be physically distributed throughout a computer system and may be accessed by one or more microprocessors such as microprocessor 100, for example. In one embodiment, microprocessor 100 is an example of a microprocessor which implements the ×86 architecture such as an Athlon™ processor, for example. However, other embodiments are contemplated which include other types of microprocessors.

In the illustrated embodiment, microprocessor 100 includes a first level one (L1) cache and a second L1 cache: an instruction cache 101A and a data cache 101B. Depending upon the implementation, the L1 cache may be a unified cache or a bifurcated cache. In either case, for simplicity, instruction cache 101A and data cache 101B may be collectively referred to as L1 cache 101 where appropriate. Microprocessor 100 also includes a pre-decode unit 102 and branch prediction logic 103 which may be closely coupled with instruction cache 10A. Microprocessor 100 also includes a fetch and decode control unit 105 which is coupled to an instruction decoder 104; both of which are coupled to instruction cache 101 A. An instruction control unit 106 may be coupled to receive instructions from instruction decoder 104 and to dispatch operations to a scheduler 118. Scheduler 118 is coupled to receive dispatched operations from instruction control unit 106 and to issue operations to execution unit 124. Execution unit 124 includes a load/store unit 126 which may be configured to perform accesses to data cache 101B. Results generated by execution unit 124 may be used as operand values for subsequently issued instructions and/or stored to a register file (not shown). Microprocessor 100 includes an on-chip L2 cache 130 which is coupled between instruction cache 101A, data cache 101B and the system memory. Microprocessor 100 also includes a bus interface unit 160 coupled between the cache units and system memory. Microprocessor 100 further includes a prefetch unit 177 coupled to L1 cache 101 and L2 cache 130.

Instruction cache 101A may store instructions before execution. Functions which may be associated with instruction cache 101A may be instruction fetching (reads), instruction pre-fetching, instruction pre-decoding and branch prediction. Instruction code may be provided to instruction cache 106 by pre-fetching code from the system memory through buffer interface unit 140 or as will be described further below, from L2 cache 130. In one embodiment, instruction cache 10A may be implemented as a four-way set-associative cache, although other embodiments are contemplated in which instruction cache 101A may be implemented in various other configurations (e.g., n-way m-set-associative, where n and m may be any number). In one embodiment, instruction cache 101A may be configured to store a plurality of cache lines where the number of bytes within a given cache line of instruction cache 10A is implementation specific. Further, in one embodiment instruction cache 101A may be implemented in static random access memory (SRAM), although other embodiments are contemplated which may include other types of memory. It is noted that in one embodiment, instruction cache 101A may include control circuitry (not shown) for controlling cache line fills, replacements, and coherency, for example.

Instruction decoder 104 may be configured to decode instructions into operations which may be either directly decoded or indirectly decoded using operations stored within an on-chip read-only memory (ROM) commonly referred to as a microcode ROM or MROM (not shown). Instruction decoder 104 may decode certain instructions into operations executable within execution unit 124. Simple instructions may correspond to a single operation. In some embodiments, more complex instructions may correspond to multiple operations.

Instruction control unit 106 may control dispatching of operations to the execution unit 124. In one embodiment, instruction control unit 106 may include a reorder buffer for holding operations received from instruction decoder 104. Further, instruction control unit 106 may be configured to control the retirement of operations.

The operations and immediate data provided at the outputs of instruction control unit 106 may be routed to scheduler 118. Scheduler 118 may include one or more scheduler units (e.g. an integer scheduler unit and a floating point scheduler unit). It is noted that as used herein, a scheduler is a device that detects when operations are ready for execution and issues ready operations to one or more execution units. For example, a reservation station may be a scheduler. Each scheduler 118 may be capable of holding operation information (e.g., bit encoded execution bits as well as operand values, operand tags, and/or immediate data) for several pending operations awaiting issue to an execution unit 124. In some embodiments, each scheduler 118 may not provide operand value storage. Instead, each scheduler may monitor issued operations and results available in a register file in order to determine when operand values will be available to be read by execution unit 124. In some embodiments, each scheduler 118 may be associated with a dedicated one of execution unit 124. In other embodiments, a single scheduler 118 may issue operations to more than one of execution unit 124.

In one embodiment, execution unit 124 may include an execution unit such as and integer execution unit, for example. However in other embodiments, microprocessor 100 may be a superscalar processor, in which case execution unit 124 may include multiple execution units (e.g., a plurality of integer execution units (not shown)) configured to perform integer arithmetic operations of addition and subtraction, as well as shifts, rotates, logical operations, and branch operations. In addition, one or more floating-point units (not shown) may also be included to accommodate floating-point operations. One or more of the execution units may be configured to perform address generation for load and store memory operations to be performed by load/store unit 126.

Load/store unit 126 may be configured to provide an interface between execution unit 124 and data cache 101B. In one embodiment, load/store unit 126 may be configured with a load/store buffer (not shown) with several storage locations for data and address information for pending loads or stores. The load/store unit 126 may also perform dependency checking on older load instructions against younger store instructions to ensure that data coherency is maintained.

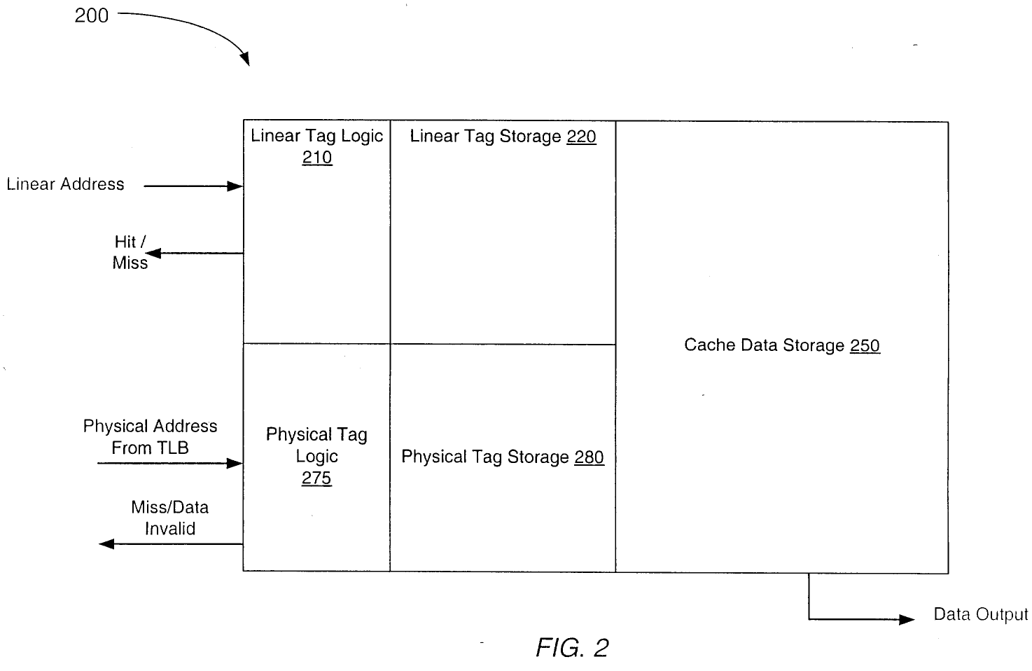

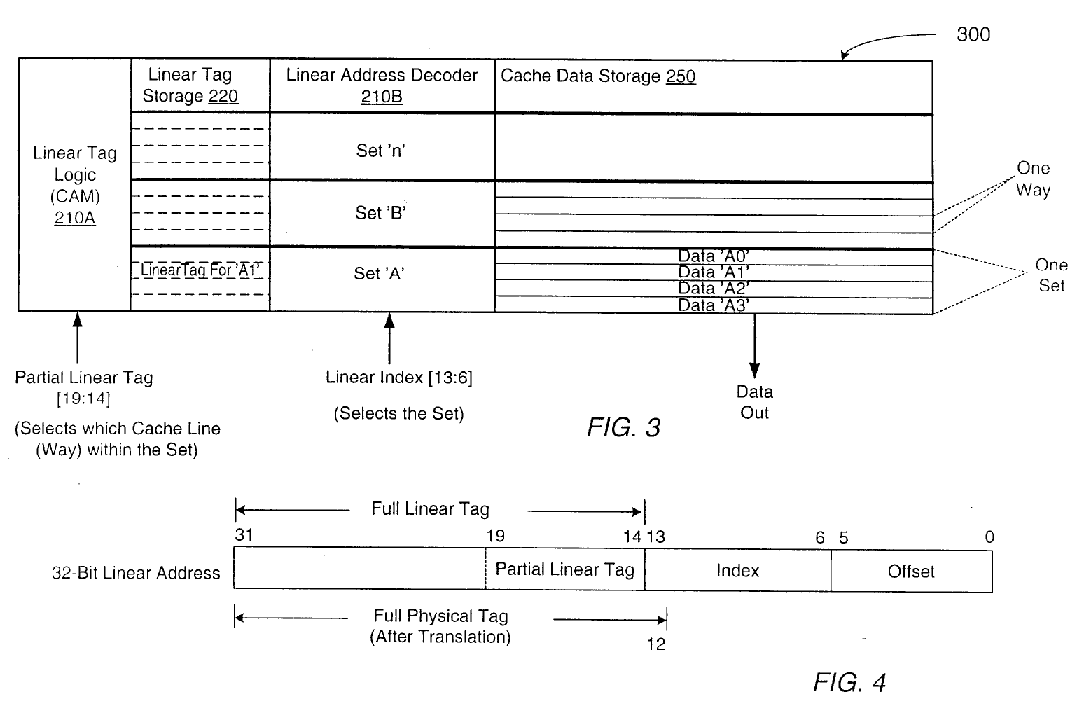

Data cache 101B is a cache memory provided to store data being transferred between load/store unit 126 and the system memory. Similar to instruction cache 101A described above, data cache 101B may be implemented in a variety of specific memory configurations, including a set associative configuration. In one embodiment, data cache 101B and instruction cache 101A are implemented as separate cache units. Although as described above, alternative embodiments are contemplated in which data cache 101B and instruction cache 101A may be implemented as a unified cache. In one embodiment, data cache 101B may store a plurality of cache lines where the number of bytes within a given cache line of data cache 101B is implementation specific. Similar to instruction cache 101A, in one embodiment data cache 101B may also be implemented in static random access memory (SRAM), although other embodiments are contemplated which may include other types of memory. Further, as will be described in greater detail below in conjunction with the description of FIG. 2 and FIG. 3, in one embodiment, data cache 101B may also be implemented as a four-way set-associative cache, although other embodiments are contemplated in which data cache 101B may be implemented in various other configurations (e.g., n-way m-set-associative, where n and m may be any number). It is also noted that in one embodiment, data cache 101B may include control circuitry (not shown) for controlling cache line fills, replacements, and coherency, for example.

L2 cache 130 is also a cache memory which may be configured to store instructions and/or data. In one embodiment, L2 cache 130 may be larger than L1 cache 101 and may store instructions and data which do not fit within L1 cache 101. In the illustrated embodiment, L2 cache 130 may be an on-chip cache and may be configured as either fully associative or set associative or a combination of both. However it is also noted that in other embodiments, L2 cache 130 may reside off-chip. In one embodiment, L2 cache 130 may store a plurality of cache lines. It is noted that L2 cache 130 may include control circuitry (not shown) for controlling cache line fills, replacements, and coherency, for example.

Bus interface unit 160 may be configured to provide a link from microprocessor 100 to an external input/output (I/O) device via a non-coherent I/O link, for example. In one embodiment, one such bus interface unit 160 may include a host bridge (not shown). In addition, bus interface unit 160 may provide links between microprocessor 100 and other microprocessors via coherent links. In one embodiment, bus interface unit 160 may include an interface (not shown) to any suitable interconnect structure, such as a packet-based interconnect compatible with HyperTransport™ Technology or a shared bus such as an EV-6 bus by Digital Equipment Corporation, for example. Bus interface unit 1600 may also be configured to transfer instructions and data between a system memory (not shown) and L2 cache 130 and between the system memory and L1 instruction cache 101A and L1 data cache 101B as desired. Further, in embodiments in which L2 cache 130 resides off-chip, bus interface 160 may include circuitry (not shown) for controlling accesses to L2 cache 130.

Referring to FIG. 2, a block diagram of one embodiment of a cache system is shown. Cache system 200 is representative of L1 data cache 101B described above in conjunction with the description of FIG. 1. However, it is contemplated that in other embodiments, cache system 200 may also be representative of the L1 instruction cache 101A shown in FIG. 1. Cache system 200 includes a cache data storage 250 coupled to a linear tag storage 220 and to a physical tag storage 280. Cache system 200 further includes a linear tag logic unit 210 which is coupled to linear tag storage 220 and a physical tag logic unit 275 which is coupled to physical tag storage 280. In one embodiment, cache system 200 may be implemented as a four-way set-associative cache. Although other embodiments are contemplated in which other numbers of ways may be used. It is further noted that in yet another embodiment, cache subsystem 200 may also be representative of a trace cache system (not shown).

Cache data storage 250 may be a storage array including a plurality of locations or entries configured to store a plurality of cache lines of data and/or instructions. In addition, each entry within cache storage 250 may be configured to store a copy of the linear tag corresponding to the cache line stored in the entry. Cache data storage 250 may include a plurality of memory units which are arranged into independently accessible storage blocks. The cache lines may be stored such that a subset of four cache lines are grouped together in a set. Each set may be selected by a respective subset of the address bits of the linear address, referred to as a linear index. Each cache line of a given set may be selected by another respective subset of the address bits of the linear address, referred to as a linear tag.

Linear tag storage 220 may be a storage array configured to store linear cache line tag information. As described above, the address information in a tag is used to determine if a given piece of data is present in the cache during a memory request. Further, this linear tag information is referred to as a linear tag. As described in greater detail below in conjunction with the description of FIG. 4, in one embodiment, a linear tag may be a partial linear tag comprising a subset of the linear address bits of a full linear tag. For example, a partial linear tag may include bits 14 through 19 of a 32-bit linear address and a linear index may include bits 6 through 13. In embodiments using a full linear tag, a full linear tag may include bits 14 through 31 of a 32-bit linear address. In addition, the linear tag and the partial linear tag do not include any bits which may be part of the linear index.

Physical tag storage 280 may be a storage array configured to store physical cache line tag information, generally referred to as a physical tag. As described above, the address information in a tag is used to determine if a given piece of data is present in the cache during a memory request. As described in greater detail below in conjunction with the description of FIG. 4, in one embodiment, a physical tag may be a subset of physical address bits of a physical address. For example, in the illustrated embodiment a full physical tag includes bits 12 through 31 of a 32-bit physical address.

Linear tag logic 210 may be configured to receive linear addresses and to determine if a requested piece of data resides in the cache storage 250. For example, a memory request includes a linear (virtual) address of the requested data. A subset or portion of the linear address (e.g., index) may specify the set of cache lines within the cache data storage 250 to be accessed. In one embodiment, linear tag logic 210 may include address decoder logic (not shown) which may decode the index portion of the received linear address which may select the set of cache lines which may contain the requested data. In addition, compare logic such as a content addressable memory (CAM) mechanism (not shown), for example, within linear tag logic 210 may compare another portion or subset of the address bits of the requested linear address with the copies of the partial linear tags stored with their corresponding cache lines within cache data storage 250. If there is a match between the requested address and an address associated with a given partial linear tag, the cache line of data may be output from cache data storage 250. The offset bits may be used to further select only the requested bytes of data. Further, in an alternative embodiment, linear tag logic 210 may also be configured to signal whether the cache request is a hit or a miss. If there is a match, a hit may be indicated as described above and if there is no matching partial linear tag, a miss may be indicated.

While cache system 200 is performing an access using the linear address as described above, the translation logic associated with the translation lookaside buffers (TLB) (not shown) may be translating a portion of the requested linear address into a physical address. If a cache request results in a hit using the partial linear tag, there exists a possibility that the data is not valid and may be referred to as a false hit. This may be due to the use of a partial linear tag being used as the linear tag. To prevent invalid data from being used by the requester, physical tag logic 275 may be configured to receive the translated physical address from the TLB and to perform a physical tag compare. In one embodiment, compare logic such as a CAM mechanism (not shown), for example, within physical tag logic 275 may compare a subset of the address bits of the requested physical address with each physical tag stored within the physical tag storage 280. If physical tag logic 275 determines that the request is a hit, nothing is done. However, if physical tag logic 275 determines that the request is a miss, the requester should be notified that the data it received is not valid. Accordingly, physical tag logic 275 may notify the requester that the data is invalid using an invalid data signal. This implementation may remove the physical translation of the address and subsequent physical tag lookup from the critical path of data retrieval from the cache system.

In addition, to perform cache line replacement, linear tag logic 210 may perform a compare of the partial linear tags stored within linear tag storage 220. In one embodiment, this compare of the partial linear tags stored within linear tag storage 220 may happen at substantially the same time that physical tag logic 275 performs a compare of the physical tags. However, in alternative embodiments, this compare of the partial linear tags stored within linear tag storage 220 may happen before physical tag logic 275 performs a compare of the physical tags.

Turning to FIG. 3, a logical diagram of the embodiment of a partial linearly tagged cache system of FIG. 2 is shown. Components that correspond to those shown in FIG. 2 are numbered identically for clarity and simplicity. Cache system 300 includes a linear tag logic unit 210A, a linear address decoder 210B and a cache storage 250. It is noted that linear tag logic 210A and linear address decoder 210B may both be included in linear tag logic 210 of FIG. 2. They are shown in greater detail in FIG. 3 to further illustrate how the sets and ways of the cache are selected.

As described above in conjunction with the description of FIG. 2, cache data storage 250 may be a storage array including a plurality of locations or entries configured to store a plurality of cache lines of data and/or instructions. In addition, each entry within cache storage 250 may be configured to store a copy of the partial linear tag corresponding to the cache line stored in the entry.

In the illustrated embodiment, cache storage 250 is implemented as an four-way set associative cache, where each set includes four cache lines or ways. The sets are designated as Set A, Set B and Set n, where n may be any number. The four cache lines of Set A are designated Data A0-Data A3.

As described above in conjunction with the description of FIG. 2, linear tag storage 220 may be a storage array configured to store linear cache line tag information. The linear tag information is referred to as a linear tag. In the illustrated embodiment, the linear tags may be partial linear tags comprising linear address bits 19:14 (i.e., not all the linear tag bits are used for the partial linear tag). It is noted that in other embodiments other numbers of linear tag bits may be used for the partial linear tag.

Each set may be selected by a respective subset of the address bits of the linear address, referred to as a linear index. Accordingly, linear address decoder 210B may decode the index field of the linear address to select the set. A particular cache line of a given set of cache lines may be selected by another respective subset of the address bits of the linear address, referred to as a partial linear tag. Thus, linear tag logic 210A may be configured to compare the received linear address with the copies of the partial linear tags stored with the data in cache data storage 250. In the illustrated embodiment, the linear tags are partial linear tags and only use bits 14 through 19. The requested bytes of data are selected by another respective subset of the address bits of the linear address. This subset is referred to as the offset. Other logic (not shown) associated with cache storage 250 may use the offset to select the requested bytes of data from the selected cache line.

Referring to FIG. 4, a diagram of one embodiment of a linear address including an exemplary partial linear tag is shown. A 32-bit linear address is divided into various fields. Beginning on the right from bit 0 through bit 5, the first field is an Offset field. As described above, the Offset is used to select the requested bytes of data from the selected cache line. The field including bit 6 through bit 13 is designated as the Index. As described above, the Index may be used to select a group or set of cache lines. The field including bit 14 through bit 19 is a partial linear tag field. As described above, a partial linear tag may be used to select the particular cache line or way from the set selected by the Index.

In addition, for discussion purposes, a full physical tag is shown occupying bits 12 through 31 of the 32-bit address. It is noted however that in other embodiments, other numbers of bits may be used for the full physical tag. Further, a full linear tag is shown occupying bits 13 through 31 of the 32-bit linear address.

It is noted that other embodiments are contemplated in which each of the fields may be delineated using different numbers of address bits. For example in such an embodiment, the partial linear tag may include other numbers of bits and may be implemented using a different range of bits.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A cache memory system comprising:
a cache storage for storing a plurality of cache lines, wherein said cache storage is configured to store a respective partial linear tag corresponding to each of said plurality of cache lines; and
a linear tag logic unit coupled to said cache storage and configured to receive a cache request including a linear address and to select a particular cache line in response to a subset of bits of said linear address matching the partial linear tag corresponding to said particular cache line.

2. The cache memory system as recited in claim 1, wherein said linear address includes a first subset of bits forming and index and a second subset of bits, wherein said partial linear tag corresponding to said particular cache line includes some, but not all, of said second subset of bits.

3. The cache memory system as recited in claim 2, wherein said linear tag logic is further configured to select a set of said plurality of cache lines using said index.

4. The cache memory system as recited in claim 2 further comprising a physical tag storage coupled to said cache storage and configured to store a respective physical tag corresponding to each of said plurality of cache lines.

5. The cache memory system as recited in claim 4, wherein said linear tag logic unit is further configured to provide one or more bytes of said particular cache line to a requester in response to said second subset of bits of said linear address matching the partial linear tag corresponding to said particular cache line.

6. The cache memory system as recited in claim 5 further comprising a physical tag logic unit coupled to said physical tag storage and configured to receive a physical address corresponding to said cache request and to determine whether said particular cache line is stored within said cache storage by comparing a subset of physical address bits with each respective physical tag.

7. The cache memory system as recited in claim 6, wherein said physical tag logic unit is further configured to signal a miss in response to determining that said particular cache line is not stored within said cache storage.

8. The cache memory system as recited in claim 7, wherein said physical tag logic unit is further configured to provide an invalid data signal in response to signaling said miss and if said linear tag logic unit has provided said one or more bytes of said particular cache line to said requester.

9. The cache memory system as recited in claim 6 further comprising a linear tag storage coupled to said linear tag logic unit and configured to store said respective partial linear tag corresponding to each of said plurality of cache lines.

10. The cache memory system as recited in claim 9, wherein said linear tag logic unit is further configured to compare said second subset of linear address bits with each of said partial linear tags stored within said linear tag storage.

11. The cache memory system as recited in claim 2, wherein said linear tag logic unit is further configured to signal a miss in response to said subset of bits of said linear address not matching any respective partial linear tags.

12. A microprocessor comprising:
an execution unit; and
a cache memory system coupled to said execution unit, wherein said cache system includes:
a cache storage for storing a plurality of cache lines, wherein said cache storage is configured to store a respective partial linear tag corresponding to each of said plurality of cache lines; and
a linear tag logic unit coupled to said cache storage and configured to receive a cache request including a linear address and to select a particular cache line in response to a subset of bits of said linear address matching the partial linear tag corresponding to said particular cache line.

13. The microprocessor as recited in claim 12, wherein said linear address includes a first subset of bits forming an index and a second subset of bits, wherein said partial linear tag corresponding to said particular cache line includes some, but not all, of said second subset of bits.

14. The microprocessor as recited in claim 13, wherein said linear tag logic is further configured to select a set of said plurality of cache lines using said index.

15. The microprocessor as recited in claim 13, wherein said cache memory system further comprising a physical tag storage coupled to said cache storage and configured to store a respective physical tag corresponding to each of said plurality of cache lines.

16. The microprocessor as recited in claim 15, wherein said linear tag logic unit is further configured to provide one or more bytes of said particular cache line to a requestor in response to said second subset of bits of said linear address matching the partial linear tag corresponding to said particular cache line.

17. The microprocessor as recited in claim 16, wherein said cache memory system further comprising a physical tag logic unit coupled to said physical tag storage and configured to receive a physical address corresponding to said cache request and to determine whether said particular cache line is stored within said cache storage by comparing a subset of physical address bits with each respective physical tag.

18. The microprocessor as recited in claim 17, wherein said physical tag logic unit is further configured to signal a miss in response to determining that said particular cache line is not stored within said cache storage.

19. The microprocessor as recited in claim 18, wherein said physical tag logic unit is further configured to provide an invalid data signal in response to signaling said miss and if said linear tag logic unit has provided said one or more bytes of said particular cache line to said requester.

20. A method for retrieving data from a cache memory system, said method comprising:
storing a plurality of cache lines within a cache storage;
storing a respective partial linear tag corresponding to each of said plurality of cache lines within said cache storage;
receiving a cache request including a linear address; and
selecting a particular cache line in response to a subset of bits of said linear address matching the partial linear tag corresponding to said particular cache line.

21. The method as recited in claim 20, wherein said linear address includes a first subset of bits forming an index and a second subset of bits, wherein said partial linear tag corresponding to said particular cache line includes some, but not all, of said second subset of bits.

22. The method as recited in claim 21 further comprising selecting a set of said plurality of cache lines using said index.

23. The method as recited in claim 21 further comprising storing a respective physical tag corresponding to each of said plurality of cache lines within a physical tag storage.

24. The method as recited in claim 23 further comprising signaling a hit and providing one or more bytes of said particular cache line to a requester in response to said second subset of bits of said linear address matching the partial linear tag corresponding to said particular cache line.

25. The method as recited in claim 24 further comprising receiving a physical address corresponding to said cache request and determining whether said particular cache line is stored within said cache storage by comparing a subset of physical address bits with each respective physical tag.

26. The method as recited in claim 25 further comprising providing an invalid data signal in response to signaling said miss if said linear tag logic unit has provided said one or more bytes of said particular cache line to said requester.
